(19) United States
(12) Patent Application Publication
(10) Pub. No.: US 2008/0229117 A1
(43) Pub. Date: Sep. 18, 2008

(54) Apparatus for preventing digital piracy

(76) Inventors: Kang G. Shin, Ann Arbor, MI (US); Jisoo Yang, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 12/075,119

(22) Filed: Mar. 7, 2008

Related U.S. Application Data
(60) Provisional application No. 60/905,528, filed on Mar. 7, 2007.

(51) Int. Cl. G06F 21/22

(52) U.S. Cl. 713/190

(57) ABSTRACT

A method for preventing digital piracy in a computing environment comprises loading an application into the computing environment, wherein the application is encrypted using a cryptographic key; assigning a virtual address space to the application; loading the cryptographic key for the application into a register which is accessible only by a central processing unit; and storing an index value for the key in the register in a page table entry which corresponds to the virtual address space for the application, thereby linking the virtual address space to the key for the application.

### CROSS-REFERENCE TO RELATED APPLICATIONS

This application claims the benefit of U.S. Provisional Application No. 60/905,528, filed on Mar. 7, 2007. The disclosure of the above application is incorporated herein by reference.

### FIELD

The present disclosure relates to digital piracy and, more particularly, to a framework that protects application software programs from unauthorized observation by the underlying operating system.

### BACKGROUND

Hackers have long been empowered by operating systems' (OS) ability to read application software. For example, in a computing environment where a user has full control of the machine in addition to administrative power, it is relatively easy for a hacker to hack into an application software program. The hacker can dump, disassemble, and modify the binary image on the disk of the machine; the memory contents of a running process on the machine are completely exposed and modifiable at any time; and the hacker can debug and trace the running process and modify machine instructions or register contents on-the-fly. Many copyrighted software and digital contents have been hacked via the underlying OS after the hacker seizes control.

The computer industry and digital rights holders, who have been losing billions of dollars every year due to digital piracy, have attempted to stop this by making the OS untouchable by hackers, or by deploying an agent program for digital rights management (DRM). For instance, the Trusted Platform Module (TPM), is an industry standard that provides a trusted computing environment to applications by means of vendor-verified hardware and software. In this architecture, hackers are prevented from tampering hardware and software. On the other hand, a DRM agent program known as the Extended Copy Protection (XCP) is an example where a media right holder tries to perform DRM by means of active monitoring and controlling end-users' actions.

However, both of these anti-piracy methods are known to suffer from bad publicity. For the TPM, the controversy is due, in part, to the fact that it can deprive users of the right to do whatever they want to do with their computers. Also, end-users have to rely entirely on the trustworthiness of the companies or regulating organization for many security issues, including privacy preservation or civil rights protection. There are no physical means of preventing or detecting violation of user agreements, performed by trusted components against end-users (e.g., information collection, activity monitoring, and digital censorship). For the XCP, the obvious privacy issues and infringement of the End-User License Agreement (EULA) not only have drawn much criticism, but also have led to a legal dispute. Furthermore, there is a vulnerability in the agent uninstaller program that can allow execution of foreign code, aggravating the situation.

### SUMMARY

A method for preventing digital piracy in a computing environment comprises loading an application into the computing environment, wherein the application is encrypted using a cryptographic key; assigning a virtual address space to the application; loading the cryptographic key for the application into a register which is accessible only by a central processing unit; and storing an index value for the key in the register in a page table entry which corresponds to the virtual address space for the application, thereby linking the virtual address space to the key for the application.

A system architecture for preventing digital piracy in a computing environment comprises a register file, a page table, and a memory management unit. The register file is accessible to a central processing unit and is operable to store cryptographic keys associated with applications residing in the computing environment. Each application is encrypted with a corresponding cryptographic key. The page table has a plurality of page table entries. Each page table entry is configured to store an index to an entry in the register file. The memory management unit resides in the computing environment and is adapted to receive memory access requests from a given application. The memory management unit is operable to retrieve the cryptographic key for the given application from the register file using the corresponding page table entry and decrypt a physical address space associated with the memory access request using the retrieved key.

### DRAWINGS

FIG. 1 is a diagram illustrating a system architecture for preventing digital piracy in a computing environment in accordance with the present disclosure;

FIG. 2A is a diagram illustrating hardware extensions made to the ×86 architecture in accordance with the present disclosure;

FIG. 2B is a diagram illustrating the integration of a key identification field into the page table entry structure of the ×86 architecture in accordance with the present disclosure; and

FIG. 2C is a diagram illustrating the modified version of the ×86 exception frame in accordance with the present disclosure.

The drawings described herein are for illustration purposes only and are not intended to limit the scope of the present disclosure in any way.

### DETAILED DESCRIPTION

To avoid the problems of the TPM and the XCP, the system architecture of the present disclosure, referred to hereinafter as a Software-Privacy Preserving Platform (SP3), protects application software from an unauthorized observation by an underlying OS. Under the SP3, the privacy of application software is preserved, so application software vendors can securely distribute their products without requiring a trusted OS to run them. In addition, general users can use their application software without fear of being monitored.

The SP3 uses cryptography to achieve secrecy of application software and secure delivery of cryptographic keys. The SP3 uses two types of cryptography: symmetric (shared) key cryptography and asymmetric (public) key cryptography. Symmetric key cryptography shares a same key (i.e., a symmetric key) for both encryption and decryption. The SP3 uses symmetric key cryptography to achieve secrecy of application software. For example only, the SP3 may use one of several symmetric key algorithms, including but not limited to the Advanced Encryption Standard and the Data Encryption Standard.

On the other hand, asymmetric key cryptography uses separate keys—a public key (Kp+) and a private key (Kp−)—for encryption and decryption. The SP3 uses public key cryptography to achieve secure delivery of the symmetric key. For example only, the SP3 may use one of several asymmetric key algorithms, including but not limited to the RSA.

The following illustrates one embodiment of a secure method of delivering an application software program using cryptography. In this illustration, an application software vendor delivers the application software program to a SP3-enabled computing environment. An underlying OS is not trusted, but a hardware processor—a central processing unit (CPU)—of the computer system is trusted.

First, a unique public key pair (Kp+, Kp−) is assigned to each physical instance of the CPU. The public, including the owner of the CPU, are only allowed to know the Kp+, but the Kp− is kept secret in the CPU. Next, to purchase the application software program from the application software vendor, a buyer supplies the vendor the Kp+ on which the application software program is to run.

Then, the application software vendor picks a symmetric key (Ks) of its choice and encrypts the application software program with the Ks, which is encrypted with the buyer-supplied Kp+. The encrypted software program as well as the encrypted Ks is then transferred to the buyer. When the buyer loads the encrypted program into the SP3-enabled computing environment, the encrypted program is loaded to a main memory of the computing environment. For example only, the main memory may include but is not limited to random access memory (RAM), dynamic RAM (DRAM), static RAM, synchronous DRAM, or any device capable of supporting high-speed buffering of data for the CPU. The CPU performs asymmetric key decryption using the Kp− to retrieve the Ks and performs symmetric key decryption using the Ks to decrypt the application software program in the main memory.

In this embodiment, the application software program is securely delivered to the SP3-enabled computing environment without trusting the OS. Delivered to the system securely, the application software program loaded into the main memory is ready to be executed by the CPU. The actual execution should involve symmetric key encryption and decryption of the application software program, but the encryption/decryption must be done without trusting the OS. That is, the OS should be able to manage the main memory, yet should be prevented from accessing the decrypted form of the application software program. To address this problem, the SP3 introduces an access control mechanism and architectural extensions to the CPU and a memory management unit (MMU) of the computing environment as described herein. The SP3 assumes that the CPU at least supports a plurality of privileges, namely privileged/unprivileged modes of operation.

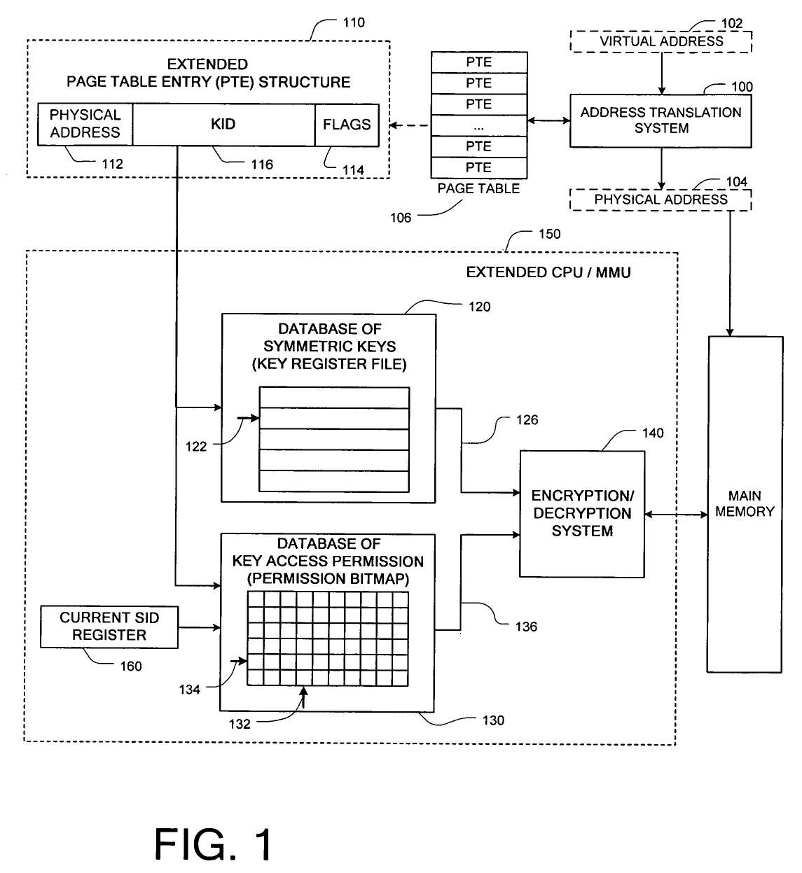

Referring now to FIG. 1, the SP3 provides software privacy protection to each SP3 domain. Permission to access the decrypted memory content is determined based on the SP3 domain. Each SP3 domain of a computing environment is uniquely identified by a SP3 domain identification (SID) value, which is assigned to each SP3 domain. The currently operating SP3 domain of a CPU/MMU 150 is represented by the SID value stored in a special hardware register (i.e., a current SID register 160) on the CPU/MMU 150. The current SID register 160 stores the SID value in order for the CPU/MMU 150 to be aware of the SP3 domain in which the CPU/MMU 150 is currently operating.

The SP3 domain of the CPU/MMU 150 is used to determine the set of access permissions of the CPU/MMU 150. A change of the SID value in the current SID register 160 means that the SP3 domain of the CPU/MMU 150 is changed, and therefore the CPU/MMU 150 has a different set of access permissions. In one embodiment where the computing environment only supports a single thread of execution, such as a uniprocessor system, it may be sufficient to implement the single current SID register 160 in the CPU/MMU 150. In another embodiment where the computing environment supports multiple threads of execution, such as a multi-processor, a multi-core, or a hyper-threaded system, each processing unit (logical or physical) may have its own current SID register.

The base methodology for protecting software privacy is to encipher (i.e., encrypt or decrypt) the memory content using symmetric cryptography. In the SP3, the unit of this protection is memory pages. Pages are the management unit of a paged MMU that can be found on most modern CPU's.

The CPU/MMU 150 includes a paged MMU that uses an address translation system 100 to translate a virtual address 102 of a page to a physical address 104 of the page using the information in a page table 106. The page table 106 is an array of page table entries (PTE's). Each PTE includes a PTE structure 110 that includes a bit field 112 containing information on physical address 104 and a bit flags field 114 for storing other information. The SP3 extends the PTE structure 110 to further include a multi-bit field, or a key identification (KID) 116. The KID 116 is used to locate a symmetric key that may be used to encipher the page addressed by the PTE structure 110.

The SP3 further extends the CPU/MMU 150 to further include a database of symmetric keys 120 that have been loaded to the CPU. In one embodiment, the database of symmetric keys 120 is implemented as a hardware register file that stores symmetric keys, referred to hereinafter as a key register file. The KID value of the KID 116 serves as an index 122 to the key register file. Therefore, the KID 116 links the page referred to by the PTE structure 110 to a symmetric key in the key register file.

For example only, a page P1 may be mapped into a virtual address through a PTE E1 that has a KID value of 7. A symmetric key K1 may be stored in the key register file and may be referred to by an index number of 7. The page P1 is indirectly linked to the symmetric key K1 by means of having the index number of K1 in the KID of PTE E1. With this indirection, the symmetric key K1 is not revealed to the OS, yet the OS can fully manage a main memory and address space. In addition, the OS is allowed to directly modify the KID in any PTE.

The SP3 further extends the CPU/MMU 150 to further include a database of key access permission 130. The database of key access permission 130 includes bits that indicate whether each SP3 domain has permission to access each symmetric key. Each bit is identified by a SP3 domain and a symmetric key. Each SP3 domain is identified by its SID value, and each symmetric key is identified its KID value.

In one embodiment, the database of key access permission 130 is implemented as a hardware circuit that includes a two-dimensional bit matrix, referred to hereinafter as a permission bitmap. The SID value works as a row address 134 to the permission bitmap, and the KID value works as a column address 132 to the permission bitmap. A selected bit of the permission bitmap tells whether the SP3 domain (whose SID value selects the row) has an access to the symmetric key (whose KID value selects the column). If the bit is true, the SP3 domain is permitted to use the symmetric key.

The permission bitmap is used in conjunction with the key register file. The permission bitmap determines whether a page mapped via a PTE should be enciphered by the CPU/MMU 150 using the symmetric key in the key register file indirectly selected by the KID 116. Thus, if a currently executing program accesses a page that is indirectly linked to a symmetric key (by having the page virtually mapped with a PTE whose KID 116 selects the symmetric key), and if the permission bitmap 130 indicates that the SP3 domain of the currently executing program is permitted to use the symmetric key, then an encryption/decryption system 140 is activated to encipher the page using the symmetric key. The currently executing program sees the enciphered content of the page.

For example only, the CPU/MMU 150 may execute a program whose SP3 domain is identified by an SID value of 5. The program may access a page P1 which is virtually mapped through a PTE that has a KID value of 7. In the key register file, a symmetric key K1 is stored at an index location of 7.

According to the rule, the bit at location (5,7) of the permission bitmap is checked to see if the SP3 domain with an SID value of 5 is permitted to use the symmetric key K1. If it is true, the encryption/decryption system 140 renders the enciphered image of the page using the symmetric key K1. If it is false, the encryption/decryption system 140 is disabled and therefore renders the verbatim image of the page. The OS is prohibited from directly accessing the key register file and the permission bitmap.

In one embodiment, a special KID, a null KID, disables the encryption/decryption system 140. When the null KID is used as the KID 116, the CPU/MMU 150 skips the permission check and renders the verbatim image of the page instead of enciphering the page. For example only, an integer value 0 may be used for the null KID. The null KID may be used to provide backward compatibility to legacy software and hardware or may be used as a simple way of providing virtual memory region that does not have to be protected by the SP3.

In one embodiment, the encryption/decryption system 140 may be implemented on a memory cache boundary, such as a Level 2 (L2) cache. The physical memory always has encrypted data, but the L2 cache may have decrypted data, depending on the key permission. Therefore, the permission check and subsequent enciphering are performed upon cache line fill and flush. Since the size of a cache line is smaller than the size of a page, the enciphering is partially performed on a cache line-sized region of a page at a time.

In another embodiment of the encryption/decryption system 140, the enciphering may be performed on the entire page as a whole. This embodiment may be as simple as directly enciphering the whole page upon every access of the main memory. This embodiment may be a complex scheme, such as maintaining two copies of a page where one copy always has the verbatim (encrypted) image of the page and the other copy always has the decrypted image of the page. In the latter scheme, the encryption/decryption system 140 renders the right image of the page by properly selecting one of the two copies according to the key permission.

In yet another embodiment regarding the encryption/decryption system 140, software may be used to emulate the enciphering hardware as well as the extended CPU/MMU 150. The software may intercept memory access requests and may properly enforce the access rule and encipher the requested page accordingly.

Interrupts and exceptions during the execution of an application software program may cause the OS to change the execution of the application software program. Thus, on occurrence of these events, the current SP3 domain is changed to a special SP3 domain reserved for the OS. In one embodiment, an SID value of 0 can be used to represent the special SP3 domain. During the SP3 domain change, the CPU/MMU 150 securely stores the outgoing SIP3 domain's execution context by encrypting the values of hardware registers (e.g., the key register file) and the current SID register 160. This encrypted execution context may be stored in the main memory.

Later, when the OS wants to resume the interrupted program, the OS executes a special instruction (i.e., a Secret instruction) to restore the interrupted SP3 domain. The Secret instruction uses the encrypted execution context which was securely saved. This secure interrupt mechanism is provided in order to prevent information leak via hardware registers and overriding the execution context.

For the creation and deletion of the SP3 domain, the SP3 includes two system instructions: Alloc and Free. Alloc creates the SP3 domain by assigning a SID value and initializing the permission bitmap. Symmetric keys are also loaded into the key register file from an executable image after public key decryption. Free deletes the SP3 domain by revoking the permission bitmap and releasing the SID value.

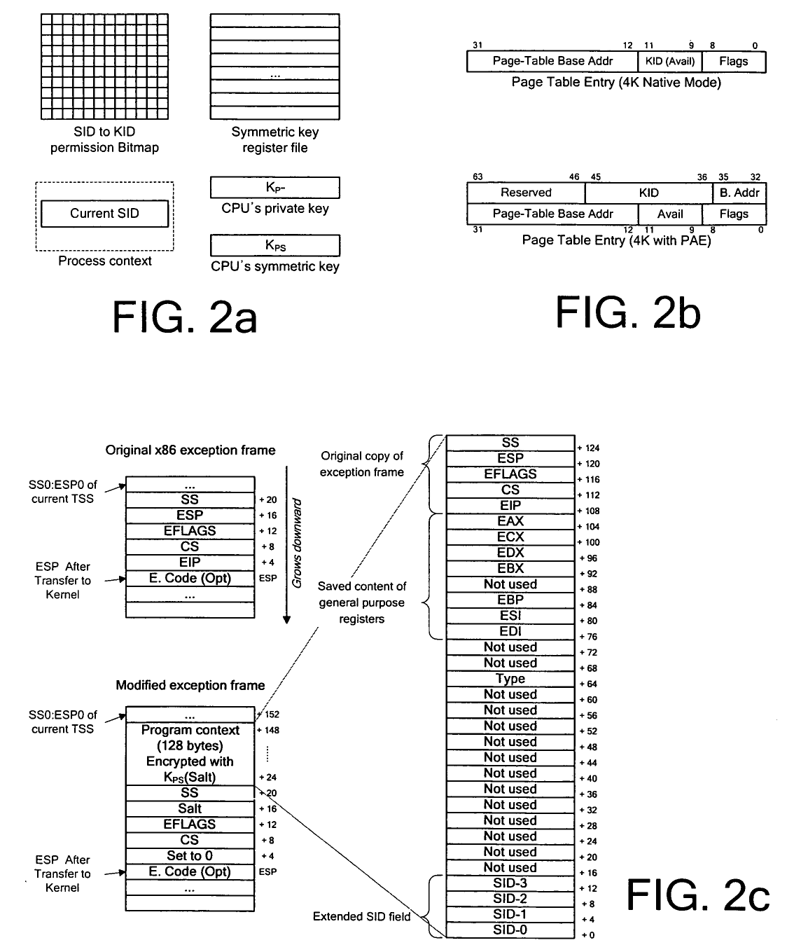

Referring now to FIG. 2a, one particular implementation of the SP3 is described herein using a specific CPU which is a real-world, widely-used commercial processor. This specific example, presented below, is for the purpose of illustration only and is not intended to limit the present disclosure. The ×86 architecture is a CPU architecture that includes a paging MMU and supports multiple privilege modes. The ×86 architecture is the architecture of many real-world CPU's. In this example implementation, the SP3 is applied to the ×86 architecture, and the application is referred to hereinafter as a SP3-×86.

Most structures of the SP3-×86 are straightforward realizations of the constructs defined in the SP3. The SP3-×86 includes a current SID register, a symmetric key register file, a SID to KID permission bitmap, a private key of a CPU, and a symmetric key (Kps) of the CPU. The SP3-×86 extends the current SID register to include an ×86 execution context. The CPU uses the Kps to encrypt the ×86 execution context upon interrupt. The value of the Kps is chosen when the CPU is manufactured.

Referring now to FIG. 2b, the integration of a KID into the PTE structure of the ×86 architecture is shown. In the native paging mode of the ×86 architecture, only 3 bits are available for the KID. In the Physical Address Extension (PAE) paging mode of the ×86 architecture, 27 bits of a reserved field are available for the KID. Under the PAE paging mode, the actual number of bits required for the KID is determined based on the size of KID space, which may be determined when a particular system architecture is designed. In FIG. 2b, 10 bits of the reserved field is selected as the KID, making the KID space range from 0 to 1023.

Referring now to FIG. 2c, the original version and a modified version of the ×86 exception frame (i.e., a SP3 exception frame) are shown. The SP3 exception frame can serve as the data structure holding the encrypted SP3 execution context during interrupts and exceptions of the application software program. The SP3 exception frame is generated on a kernel stack upon interruption of the SP3 domain. Thus, all exceptions, faults, and interrupts will generate the SP3 exception frame if the SID value is not 0 (i.e., the SID value of the OS).

The first top 128 bytes (sixteen 32-bit words) of the SP3 exception frame is encrypted. The key used in the encryption is the Kps. To enhance security, the Kps may be perturbed with a seed value derived from the keys for pages pointed to by the Extended Instruction Pointer (EIP) and the Extended Stack Pointer (ESP) of the ×86 architecture. The seed value is stored in a Salt field of the SP3 exception frame.

The values of general-purpose registers (GPR's) and the current SID register are saved into the SP3 exception frame. The SID value is stretched using the seed value and saved to the SID-0-SID-3 fields of the SP3 exception frame to make it difficult to override the SID value. The plaintext (i.e., unencrypted) part of the SP3 exception frame follows the encrypted part. The plaintext part looks similar to the original ×86 exception frame, but the EIP of the original ×86 exception frame is masked out. In addition, the Salt field replaces the ESP of the original ×86 exception frame.

After generating the SP3 exception frame, the SID value is set to 0. The GPR's are also cleared unless the cause of the exception is a software interrupt. Thus, programs may pass system call parameters via GPR's. A Type field of the SP3 exception frame tells whether GPR's have been cleared or not, indicating that the SP3 exception frame was generated by a software interrupt or another type of exception.

Upon execution of the Secret instruction, the Salt field of the SP3 exception frame is decrypted using Kps. For safe and secure SP3 domain change, the seed value and the stretched SID value are verified against the keys for pages pointed to by the EIP and the ESP. The CPU reloads GPR's from the SP3 exception frame unless the Type field indicates the SP3 exception frame was generated by a software interrupt. This way, the OS can pass return values.

In another aspect of the invention, the SP3 defined within the context of a hardware extension may be implemented entirely as software. In this software embodiment of the invention, the software emulates or virtualizes the definitions of the SP3 hardware extensions. The emulating or virtualizing software is thus enforcing the protection rules.

For example, the SP3-×86 defined within the context of a hardware extension on the ×86 architecture may be implemented at the virtual machine (VM) level which does not require any modification to the hardware. The protection system and mechanism of the SP3 is emulated by a virtual machine monitor (VMM) that sits between the OS and the hardware. The VMM must be trusted and verified, but the fact that the protection provided by the SP3 may be achieved without hardware modification makes it applicable to any existing system. The application binary interface of the SP3 is provided to the guest OS and the application software program by this VM-based embodiment. Thus, OS's and application software written for the SP3 require no modification or recompilation to run on this VM-based embodiment.

The VMM includes data structures to emulate specific hardware components of the SP3 that include the key register file, the current SID register, the permission bitmap, and the KID. The extended instructions may be emulated as an extension of the undefined instruction exception handler of the VMM. The op-codes of the extended instructions generate an invalid opcode exception. The undefined instruction exception handler thus emulates the behavior of the extended instructions. This is handled transparently, so the guest OS and the application software do not experience any differences.

The SP3 secure interrupt extension may be implemented as follows. When an application software program running with a non-zero SID value gets interrupted or raises an exception, the VMM generates the extended interrupt frame on the guest OS′ stack before the VMM transfers control to the guest OS.

In this VM-based embodiment of the invention, the VMM is responsible for rendering the right image of a memory page. That is, encryption and decryption of the page must be performed according to the current SID value and the KID. If a page is referenced by a PTE with a non-zero KID, the page must be decrypted by the symmetric key selected by the KID value. The decrypted page should be referred to instead of the original page.

The SP3 memory logic may be implemented as follows. The original page is encrypted and replicated to another memory location, and each replicated page represents the decryption of the associated symmetric key. The replicated pages are managed separately in the VMM's privately-maintained memory areas. The VMM provides the OS a virtualized view of the page table with the KID, but for the actual page table, the VMM redirects a PTE to a replicated page. Thus, an SP3 domain with valid permission will access the replicated (instead of the original) page. The VMM keeps track of the relation between the original page and the replicated page.

The VMM keeps track of every page used by the VM. Each page is associated with a type and a reference counter. Under this scheme, pages used as a page table and a page directory are tightly controlled. Any update on the page table or the page directory is monitored and validated by the VMM.

This facility of the VMM may be utilized to realize the PTE structure and the key register file of the SP3 when the OS updates a page table entry with a non-zero KID value. The PTE structure contains the physical/virtual address of the PTE as well as a page frame number of the original/decrypted page. During initialization, the VMM reserves a physical page frame pool for the decrypted image.

To check the permission of the application software program to view a decrypted page, the VMM modifies the corresponding PTE to generate a page fault exception to facilitate such permission check and page decryption. A page mapped with a non-zero KID value is referred to hereinafter as a SP3 page, and the PTE for the SP3 page is referred to hereinafter as a SP3 PTE.

This is realized by exploiting the present bit of the SP3 PTE so that the CPU can generate a non-present page fault exception. The present bit is purposely cleared even though the page is physically mapped by the OS kernel. The page fault handler of the VMM is modified to filter the non-present page fault exception by examining the KID that caused the non-present page fault exception.

When a page fault is generated by an SP3 PTE, the VMM fixes the page fault by setting the present bit with an appropriate value on PTE. Which page is used is determined by following the SP3 page access rule: if the current SID value has access to the symmetric key of the KID, the VMM uses the decrypted image. In other cases, the original (encrypted) page is used. During this process, the dirty bit of the PTE may be checked to synchronize between the original page and the decrypted page.

Once the SP3 page is made present, access of the SP3 page does not generate any page fault, and the application software program can proceed. The present bits are cleared when the current SID value changes. This ensures that the access permissions of the SP3 pages are re-evaluated when another SP3 domain accesses the SP3 pages. The VMM maintains a list of SP3 PTE's that should be made non-present upon change of the SID value. When the VMM re-evaluates a SP3 PTE by setting the present bit, it also adds the PTE to the list. Later when the current SID value changes, the VMM goes through the list to clear the present bits, and the list is emptied.

After the SP3 PTE is fixed, the VMM resumes the program. It does not bounce the page fault to the guest OS, and therefore, the guest OS does not know that the page fault has occurred.

The goal of the SP3 is to provide a privacy-preserving computing environment for application software under an OS that is not trusted. The SP3 primarily protects the code, the data, and the memory content of the executable of the application software. This is done through the encryption of memory pages. Thus, the application software writer can hide sensitive information and control distribution. For example only, the sensitive information may include but is not limited to proprietary code, copyrighted material, or algorithms for digital rights management.

Since a file system is part of an OS, application software programs that use the SP3 (i.e., SP3 applications) can securely store private data to a file. For example, an SP3 application can allocate a SP3-protected memory buffer and fill the buffer with private data. Then, the SP3 application can perform write on the file with a pointer to the buffer. The files system reads only the encrypted private data from the buffer. Since the file system does not (or should not) care about data it sees, the file system proceeds to write the encrypted private data to the file.

The secure file system may be applied to network communications. In this case, the SP3 application passes the memory pointer of the SP3 to the network stack. The other end of a network communication may be either an SP3 application or a system that can decrypt the data correctly.

In another application, the SP3 can serve as an encryption engine for block encryption. To do this, an application software program prepares data in an SP3-protected memory region. Then, the application software program creates an alias map on the memory region, but with a zero KID value. From the memory region, the application software program can see the encrypted data.

The above description is merely exemplary in nature and is not intended to limit the present disclosure, application, or uses.

What is claimed is:

1. A method for preventing digital piracy in a computing environment, comprising:
loading an application into the computing environment, wherein the application is encrypted using a cryptographic key;
assigning a virtual address space to the application;
loading the cryptographic key for the application into a register which is accessible only by a central processing unit; and
storing an index value for the key in the register in a page table entry which corresponds to the virtual address space for the application, thereby linking the virtual address space to the key for the application.

2. The method of claim 1 further comprises encrypting the application prior to loading the application into the computing environment using a cryptographic key selected by the application vendor.

3. The method of claim 1 further comprises delivering the cryptographic key for the application to the computing environment using public key cryptography.

4. The method of claim 3 further comprises decrypting the cryptographic key for the application using a public key assigned to the central processing unit.

5. The method of claim 1 further comprises decrypting a physical address space associated with the application using the cryptographic key upon receipt of a permissible memory access request.

6. The method of claim 5 wherein decrypting the physical address space is performed by a memory management unit residing in the computing environment.

7. A system architecture for preventing digital piracy in a computing environment, comprising:
a register file accessible to a central processing unit and operable to store cryptographic keys associated with applications residing in the computing environment, each application being encrypted with a corresponding cryptographic key;
a page table having a plurality of page table entries, each page table entry configured to store an index to an entry in the register file;
a memory management unit residing in the computing environment and adapted to receive memory access requests from a given application, the memory management unit operable to retrieve the cryptographic key for the given application from the register file using the corresponding page table entry and decrypt a physical address space associated with the memory access request using the retrieved key.
